(19) United States
(12) Patent Application Publication
(10) Pub. No.: US 2017/0113598 A1
(43) Pub. Date: Apr. 27, 2017

(54) METHOD AND DEVICE FOR CONTROLLING OF SWITCHING ON AND OFF CAR LIGHTS THROUGH BLUETOOTH TECHNOLOGY

(71) Applicants: LE HOLDINGS (BEIJING) CO., LTD., Beijing (CN); Lemobile Information Technology (Beijing) Co., Ltd, Beijing (CN)

(72) Inventors: Qin HUANG, Beijing (CN); Hailan YU, Beijing (CN)

(21) Appl. No.: 15/235,064

(22) Filed: Aug. 11, 2016

Related U.S. Application Data
(63) Continuation of application No. PCT/CN2016/087014, filed on Jun. 24, 2016.

(30) Foreign Application Priority Data
Oct. 22, 2015 (CN) 201510695731.7

(51) Int. Cl. B60Q 1/08; G08C 17/02; H04W 4/00; H05B 37/02

(52) U.S. Cl. CPC B60Q 1/085; H05B 37/0272; H05B 37/0218; G08C 17/02; H04W 4/005

(57) ABSTRACT

The embodiment of the present disclosure discloses a method and device for controlling a car light switch through Bluetooth technology. The method comprises the following steps of receiving a UUID broadcast by the car lights by a mobile terminal; configuring light control services corresponding to the car lights, characteristics of the light control services, and configuration descriptors of the characteristics and establishing Bluetooth connection with the car lights according to the UUID; amending the configuration descriptors of the characteristics on the car through a Bluetooth connection to switch on or off the car lights. By the method and the device, Bluetooth connection among the mobile terminal and the car lights is established to amend the configuration descriptors of the characteristics so as to switch on or off the car lights, and thus the car lights are remotely switched on or off to provide illumination for the users.

### CROSS-REFERENCE TO RELATED APPLICATIONS

The present disclosure is a continuation of International Application PCT/CN2016/087014 filed on Jun. 24, 2016, which is based upon and claims priority to Chinese Patent Application No. 201510695731.7, entitled “METHOD AND DEVICE FOR CONTROLLING OF SWITCHING ON AND OFF CAR LIGHTS THROUGH BLUETOOTH TECHNOLOGY”, filed to State Intellectual Property Office of The P.R.C. on Oct. 22, 2015, the entire contents of all of which are incorporated herein by reference.

### FIELD OF TECHNOLOGY

The present disclosure generally relates to the technical field of remote controlling and particularly relates to a method and device for controlling of switching on and off car lights through Bluetooth technology.

### BACKGROUND

With development of the automobile manufacturing industry, the automobile is used as a transportation tool by increasing numbers of users; in order to meet users' demands on speed, safety and comfort level of the automobile, the automobile is also developing in an intelligent direction.

Car lights are also called as automotive headlamps and have experienced an evolutionary process from gas lamps, incandescent lamps, halogen lamps to xenon lamps. But now the car lights are still switched on manually. When surrounding lights are relatively dark, a user finds the car either with the help of a mobile phone or along with the dark.

Therefore, at present a technical problem demanded for being urgently solved by those skilled in the art is as follows: how to remotely switch on the car lights for illumination.

### SUMMARY

An embodiment of the present disclosure discloses a method and device for controlling of switching on the headlight through Bluetooth technology, and the method and the device are used for solving the problem that the car lights cannot be switched on remotely for illumination in the prior art.

According to one aspect of the present disclosure, the present disclosure discloses a method for controlling of switching on and off the car lights through Bluetooth technology, and the method includes the following steps of:

receiving a UUID (Universally Unique Identifier) broadcast by the car lights by a mobile terminal;

configuring light control services corresponding to the car lights, characteristics of the light control services, and configuration descriptors of the characteristics and establishing Bluetooth connection with the car lights according to the UUID;

amending the configuration descriptors of the characteristics on the car through a Bluetooth connection in order to switch on or off the car lights.

According to the other aspect of the present disclosure, the present disclosure further discloses a device for controlling of switching on and off the car lights through Bluetooth technology, and the device includes:

a UUID receiving module for receiving the UUID broadcast by the car lights;

a Bluetooth connection establishing module for configuring light control services corresponding to the car lights, characteristics of the light control services, and configuration descriptors of the characteristics and establishing Bluetooth connection with the car lights according to the UUID;

a car light switch controlling module for amending the configuration descriptors of the characteristics on the car through the Bluetooth connection in order to switch on or off the car lights.

According to still another aspect of the present disclosure, the present disclosure discloses a computer program, and the computer program includes a computer readable code; when the computer readable code is operated in an electronic device, the method for controlling of switching on and off the car lights through Bluetooth technology is implemented by the electronic device.

According to one more aspect of the present disclosure, the present disclosure discloses a computer readable media in which the computer program is stored.

The present disclosure has the advantages that:

by the method and device for controlling of switching on and off the car lights through Bluetooth technology disclosed in the embodiment of the present disclosure, the Bluetooth connection among the mobile terminal and the car lights is established to amend the configuration descriptors of the characteristics so as to switch on or off the car lights, and thus the car lights are remotely switched on or off to provide illumination for the users.

The description is only the summary of the technical solution of the present disclosure; in order to clearly understand technical measures of the present disclosure, implement the measures according to the summary of the description, and make the above or other purposes, characteristics and advantages of the present disclosure be obvious and easy to understand, specific implementing ways of the present disclosure are especially described below.

### BRIEF DESCRIPTION OF THE DRAWINGS

FIG. 1 is a flow chart of steps of the method for controlling of switching on and off the car lights through Bluetooth technology according to an embodiment of the present disclosure.

FIG. 2 is a flow chart of steps of the method for controlling of switching on and off the car lights through Bluetooth technology according to an embodiment of the present disclosure.

FIG. 3 is a schematic diagram of a scene of establishing Bluetooth connection between the mobile terminal and the car lights according to the embodiment of the present disclosure.

FIG. 4 is a structure diagram of the device for controlling of switching on and off the car lights through Bluetooth technology according to the embodiment of the present disclosure.

FIG. 5 is a structure diagram of the device for controlling of switching on and off the car lights through Bluetooth technology according to the embodiment of the present disclosure.

FIG. 6 schematically illustrates a block diagram of the electronic device used for implementing the method of the present disclosure.

FIG. 7 schematically illustrates a memory unit for storing or carrying the program code according to the method of the present disclosure.

### DESCRIPTION OF THE EMBODIMENTS

In order to clarify the purpose, the technical solution and the advantages in the embodiment of the present disclosure, the technical solution in the embodiment of the present disclosure is clearly and completely described according to the drawings; obviously, the described embodiments are only the partial embodiments instead of the entire embodiments. Based on the embodiments of the present disclosure, all other embodiments obtained by the ordinary technicians skilled in the art in the absence of creative work are in the protective range of the present disclosure.

An SDP (Service Discovery Protocol) is regarded as the core protocol of a Bluetooth protocol system, the important constituent part of a Bluetooth system and the basis of all user modes. In the Bluetooth system, a client can acquire equipment information, service information and service characteristics only through the SDP, and then mutual connection is established based on the acquired information. The SDP provides a method for discovering effective services and determines the characteristics of the effective services.

The SDP includes the following basic functions: searching service by the client based on service attribute, discovering service based on service class, browsing service, providing a determining mechanism of equipment effectiveness or service effectiveness, providing a determining mechanism of equipment failure or service failure, providing unique identification service, service class and service attribution and discovering the service on the other equipment without the third party; the SDP is applied to simple equipment and provide incremental quantity to acquire a service information mechanism and to support the service so as to discover high-speed caching of information and increase the discovery efficiency or speed of the process; the SDP is transmitted independently, utilize L2CPA as a transport layer protocol, and discover and use other discovery service protocols; besides the SDP can support creation and definition of new service without admission of a primary device.

### First Embodiment

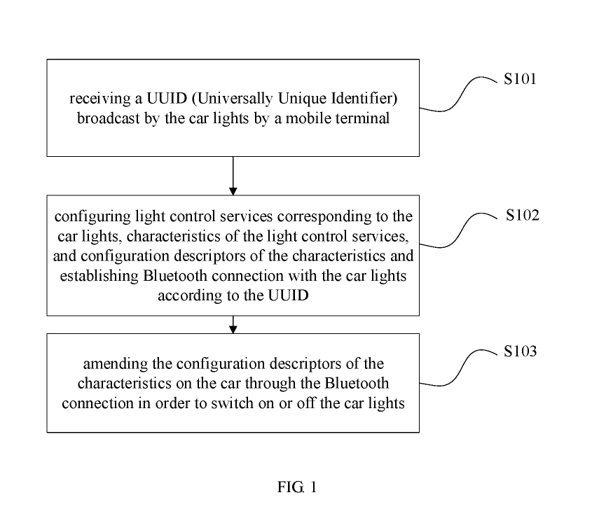

FIG. 1 shows that the embodiment of the present disclosure discloses a flow chart of steps of the method for controlling of switching on and off the car lights through Bluetooth technology.

Based on the SDP technology, the embodiment discloses a method for controlling of switching on and off the car lights through Bluetooth technology, and the method is shown in FIG. 1 and includes steps as follows:

Step S101, receiving a UUID (Universally Unique Identifier) broadcast by the car lights by a mobile terminal.

In the step, the mobile terminal may include clients such as a mobile phone, a tablet personal computer and a smart watch that have the Bluetooth function.

Step S102, configuring light control services corresponding to the car lights, characteristics of the light control services, and configuration descriptors of the characteristics and establishing Bluetooth connection with the car lights according to the UUID.

In the step, the mobile terminal implements service discovery through the SDP and discovers Link Loss Service and Tx power Service according to the received UUID. The mobile terminal discovers all the characteristic descriptors of the service through Characteristic Discovery; Light Control Characteristics are configured to the Link Loss.

S103, amending the configuration descriptors of the characteristics on the car through the Bluetooth connection in order to switch on or off the car lights.

In the step, the configuration descriptors of the characteristics include: an opening descriptor and a closing descriptor; the opening descriptor indicates that the car lights are in the switching-on state, and the closing descriptor indicates that the car light are in the switching-off state. In the embodiment of the present disclosure, if the configuration descriptor of the present characteristic is the opening descriptor, the configuration descriptor of the characteristic is amended into the closing descriptor on the car through the Bluetooth connection to switch off the car lights; if the configuration descriptor of the present characteristic is the closing descriptor, the configuration descriptor of the characteristic is amended into the opening descriptor on the car through the Bluetooth connection to switch on the car lights.

By the method for controlling of switching on and off the car lights through Bluetooth technology disclosed in the embodiment of the present disclosure, Bluetooth connection between the mobile terminal and the car lights is established to amend the configuration descriptors of the characteristics so as to switch on or off the car lights, and thus the car lights are remotely switched on or off to provide illumination for the users.

### Second Embodiment

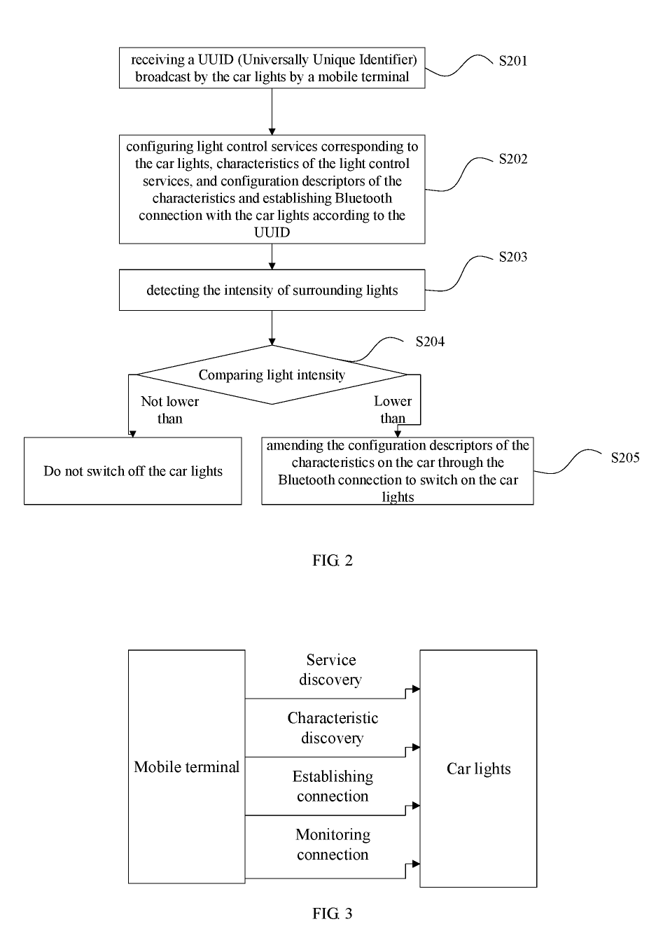

FIG. 2 shows that the embodiment of the present disclosure discloses a flow chart of steps of the method for controlling of switching on and off the car lights through Bluetooth technology.

FIG. 3 shows a schematic diagram of a scene of establishing Bluetooth connection between the mobile terminal and the car lights in the embodiment of the present disclosure.

Due to the limited electric quantity of a car battery, a method for controlling of switching on and off the car lights through Bluetooth technology is disclosed in the present embodiment of the present disclosure to save electric energy (as shown in FIG. 2) and includes the steps as follows.

Step S201, receiving a UUID (Universally Unique Identifier) broadcast by the car lights by a mobile terminal.

Step S202, configuring light control services corresponding to the car lights, characteristics of the light control services, and configuration descriptors of the characteristics and establishing Bluetooth connection with the car lights according to the UUID.

Step S203, detecting the intensity of surrounding lights.

Step S204, comparing the intensity of surrounding lights with the preset light intensity.

In the step, if the intensity of the surrounding lights is lower than the preset light intensity, namely the surrounding lights are relatively weak, and the car lights are demanded for illumination, Step S205 is implemented; if the intensity of the surrounding lights is not lower than the preset light intensity, namely the surrounding lights are relatively strong, the car lights are not demanded for illumination.

Step S205, amending the configuration descriptors of the characteristics on the car through the Bluetooth connection to switch on the car lights.

In the step, when the car lights are switched on, the mobile terminal displays a prompt that the car lights have been switched on to check by the users.

Step S206, calculating link loss of Bluetooth connection; when the link loss is more than or equal to a preset link loss threshold, the configuration descriptors of the characteristics are amended on the car to switch off the car lights.

In the step, when the link loss is more than or equal to the preset link loss threshold, the user has been far away from the car and the car lights are not demanded for illumination and can be switched off. At the moment, the mobile terminal can display a prompt that the car lights have been switched off to check by the users. In the embodiment of the present disclosure, the process of calculating link loss of Bluetooth connection includes: monitoring the intensity of received signals of Bluetooth connection, reading transmitting power of the car lights, calculating a difference value between the intensity of received signals and the transmitting power of the car lights, and taking the difference value as the link loss.

By the method for controlling of switching on and off the car lights through Bluetooth technology disclosed in the embodiment of the present disclosure, Bluetooth connection between the mobile terminal and the car lights is established to amend the configuration descriptors of the characteristics on the car so as to switch on or off the car lights, and thus the car lights are remotely switched on or off to provide illumination for the users and timely switched off, and the limited electric energy of the car is prevented from being wasted.

### Third Embodiment

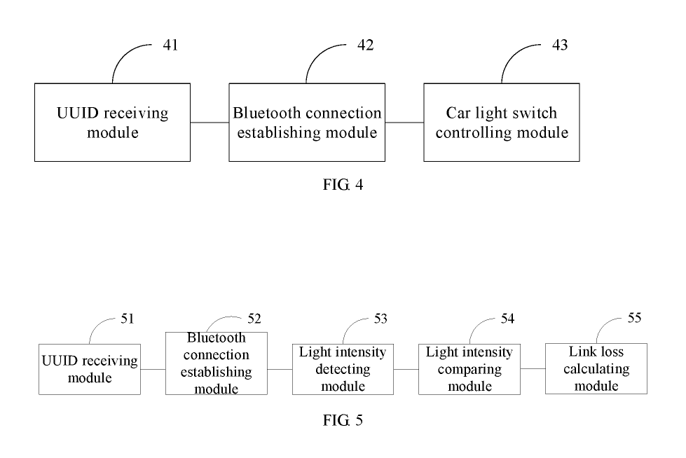

FIG. 4 shows that the embodiment of the present disclosure discloses a structure diagram of the device for controlling of switching on and off the car lights through Bluetooth technology.

The embodiment discloses the device for controlling of switching on and off the car lights through Bluetooth technology; the device can implement the method for controlling of switching on and off the car lights through Bluetooth technology disclosed in the first embodiment (as shown in FIG. 4) and may include the following modules: a UUID receiving module 41, a Bluetooth connection establishing module 42 and a car light switch controlling module 43.

In the embodiment of the present disclosure, the UUID receiving module 41 is used for receiving the UUID broadcast by the car lights; the Bluetooth connection establishing module 42 is used for searching light control services corresponding to the car lights, characteristics of the light control services, and configuration descriptors of the characteristics, and establishing Bluetooth connection with the car lights according to the UUID; the car light switch controlling module 43 is used for amending the configuration descriptors of the characteristics on the car through the Bluetooth connection in order to switch on or off the car lights.

In the Bluetooth connection establishing module 42, the mobile terminal implements service discovery through the SDP and discovers Link Loss Service and Tx power Service according to the received UUID. The mobile terminal discovers all the characteristic descriptors of the service through Characteristic Discovery; Light Control Characteristics are configured to the Link Loss.

In the car light switch controlling module 43, the configuration descriptors of the characteristics include: an opening descriptor and a closing descriptor; the opening descriptor may indicate that the car lights are in the switching-on state, and the closing descriptor may indicate that the car light are in the switching-off state. In the embodiment of the present disclosure, if the configuration descriptor of the present characteristic is the opening descriptor, the configuration descriptor of the characteristic is amended into the closing descriptor on the car through the Bluetooth connection to switch off the car lights; if the configuration descriptor of the present characteristic is the closing descriptor, the configuration descriptor of the characteristic is amended into the opening descriptor on the car through the Bluetooth connection to switch on the car lights.

By the device for controlling of switching on and off the car lights through Bluetooth technology disclosed in the embodiment of the present disclosure, Bluetooth connection between the mobile terminal and the car lights is established to amend the configuration descriptors of the characteristics so as to switch on or off the car lights, and thus the car lights are remotely switched on or off to provide illumination for the users.

### Fourth Embodiment

FIG. 5 shows that the embodiment of the present disclosure discloses a structure diagram of the device for controlling of switching on and off the car lights through Bluetooth technology.

The device for controlling of switching on and off the car lights through Bluetooth technology in the embodiment of the present disclosure can implement the method for controlling of switching on and off the car lights through Bluetooth technology disclosed in the first embodiment of the present disclosure (as shown in FIG. 5) and may include the following modules: a UUID receiving module 51, a Bluetooth connection establishing module 52, a light intensity detecting module 53, a light intensity comparing module 54 and a link loss calculating module 55.

The UUID receiving module 51 is used for receiving the UUID broadcast by the car lights; the Bluetooth connection establishing module 52 is used for searching light control services corresponding to the car lights, characteristics of the light control services, and configuration descriptors of the characteristics and establishing Bluetooth connection with the car lights according to the UUID; the light intensity detecting module 53 is used for detecting the intensity of the surrounding lights; the light intensity comparing module 54 is used for comparing the intensity of the surrounding lights with the preset light intensity; if the intensity of the surrounding lights is lower than the preset light intensity, the step of amending the configuration descriptors of the characteristics on the car through the Bluetooth connection in order to switch on the car lights is implemented; the link loss calculating module 55 is used for calculating the link loss of Bluetooth connection; when the link loss is more than or equal to the preset link loss threshold, the configuration descriptors of the characteristics are amended on the car through the Bluetooth connection in order to switch off the car lights.

In the light intensity comparing module 54, if the intensity of the surrounding lights is lower than the preset light intensity, namely the surrounding lights are relatively weak, the car lights are switched on when being demanded for illumination; if the intensity of the surrounding lights is not lower than the preset light intensity, namely the surrounding lights are relatively strong, the car lights do not need to be switched on when being not demanded for illumination. When the car lights are switched on, the mobile terminal displays a prompt that the car lights have been switched on to check by the users.

When the link loss is more than or equal to the preset link loss threshold, the user has been far away from the car and the car lights are not demanded for illumination and switched off. At the moment, the mobile terminal can display a prompt that the car lights have been switched off to check by the users. In the embodiment of the present disclosure, the process of calculating link loss of Bluetooth connection may include: monitoring the intensity of received signals of Bluetooth connection, reading transmitting power of the car lights, calculating a difference value between the intensity of received signals and the transmitting power of the car lights, and taking the difference value as the link loss.

By the device for controlling of switching on and off the car lights through Bluetooth technology disclosed in the embodiment of the present disclosure, Bluetooth connection between the mobile terminal and the car lights is established to amend the configuration descriptors of the characteristics so as to switch on or off the car lights, and thus the car lights are remotely switched on or off to provide illumination for the users and timely switched off, and the limited electric energy of the car is prevented from being wasted.

The described device embodiment is only schematic, wherein units described as separating parts may or may not be physically separated, and unit displaying parts may or may not be physically separated, that is, can be positioned at the same position or distributed to multiple network units. According to actual demands, the purpose of the solution in the present embodiment is realized by choosing all or some modules. The ordinary technicians skilled in the art can understand and implement the embodiment in the absence of creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

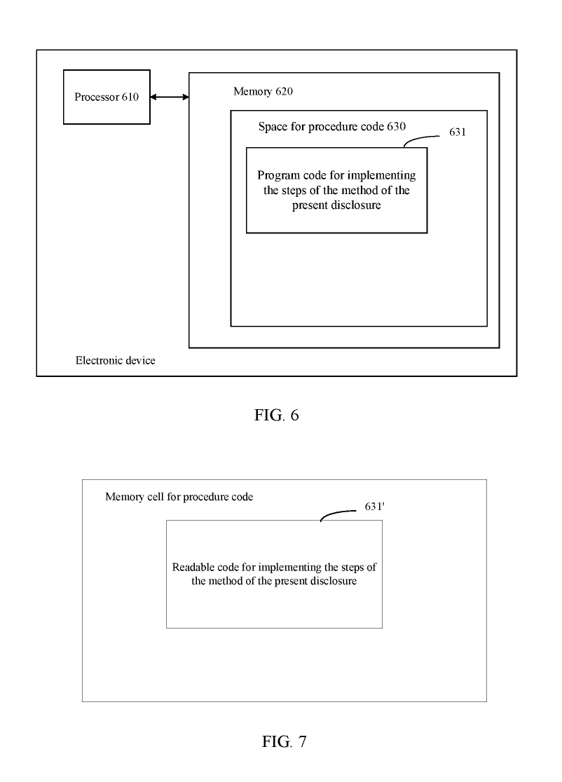

For example, FIG. 6 illustrates a block diagram of an electronic device for executing the method according the disclosure. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory units as shown in reference FIG. 7. The memory units may be provided with memory sections, memory spaces, etc., similar to the memory 620 of the server as shown in FIG. 6. The program codes may be compressed for example in an appropriate form. Usually, the memory unit includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it is illustrated that the above embodiments are only used for describing the technical solution of the present solution and are not affirmed to be restricted to the technical solution; the present disclosure is described in details according to the above-mentioned embodiments, thus the ordinary people skilled in the art shall understand that technical solutions recorded in each embodiment still can be amended or some technical characteristics thereof can be substituted equally; these amendments or substitutions don't make the essence of the corresponding technical solution break away from the spirit and scope of the technical solution in each embodiment of the present disclosure.

What is claimed is:

1. A method for controlling of switching on and off car lights through Bluetooth technology, comprising:
receiving a UUID broadcast by the car lights by a mobile terminal;
configuring light control services corresponding to the car lights, characteristics of the light control services, and configuration descriptors of the characteristics and establishing Bluetooth connection with the car lights according to the UUID;
amending the configuration descriptors of the characteristics on the car through a Bluetooth connection in order to switch on or off the car lights.

2. The method according to claim 1, wherein before the step of amending the configuration descriptors of the characteristics on the car through the Bluetooth connection in order to switch on the car lights, the method further comprising:
detecting the intensity of surrounding lights;
comparing the intensity of surrounding lights with the preset light intensity;
if the intensity of the surrounding lights is lower than the preset light intensity, the step of amending the configuration descriptors of the characteristics on the car through the Bluetooth connection in order to switch on the car lights is implemented.

3. The method according to claim 1, wherein the configuration descriptors of the characteristics include: an opening descriptor and a closing descriptor;
the step of amending the configuration descriptors of the characteristics on the car through the Bluetooth connection in order to switch on or off the car lights comprising:
if the configuration descriptor of the present characteristic is the opening descriptor, the configuration descriptor of the characteristic is amended as the closing descriptor through the Bluetooth connection to switch off the car lights;
if the configuration descriptor of the present characteristic is the closing descriptor, the configuration descriptor of the characteristic is amended as the opening descriptor through the Bluetooth connection to switch on the car lights.

4. The method according to claim 1, wherein the step of amending the configuration descriptors of the characteristics on the car through the Bluetooth connection in order to switch off the car lights comprising:
calculating link loss of Bluetooth connection;
when the link loss is more than or equal to a preset link loss threshold, the configuration descriptors of the characteristics are amended on the car through the Bluetooth connection to switch off the car lights.

5. The method according to claim 4, wherein the step of calculating link loss of Bluetooth connection comprising:
monitoring the intensity of received signals of Bluetooth connection, and reading transmitting power of the car lights;
calculating a difference value between the intensity of received signals and the transmitting power of the car lights, and taking the difference value as the link loss.

6. An electronic device for controlling of switching on and off car lights through a Bluetooth technology, comprising:
at least one processor; and
a memory communicably connected with the at least one processor for storing instructions executable by the at least one processor, wherein execution of the instructions by the at least one processor causes the at least one processor to:
receive the UUID broadcast by the car lights;
configure light control services corresponding to the car lights, characteristics of the light control services, and configuration descriptors of the characteristics and establish Bluetooth connection with the car lights according to the UUID;
amend the configuration descriptors of the characteristics on the car through the Bluetooth connection in order to switch on or off the car lights.

7. The electronic device according to claim 6, further, wherein execution of the instructions by the at least one processor causes the at least one processor to:
detect the intensity of surrounding lights;
compare the intensity of the surrounding lights with the preset light intensity; if the intensity of the surrounding lights is lower than the preset light intensity, amend the configuration descriptors of the characteristics on the car through the Bluetooth connection in order to switch on the car lights is implemented.

8. The electronic device according to claim 6, wherein the configuration descriptors of the characteristics include: an opening descriptor and a closing descriptor;
amend the configuration descriptors of the characteristics on the car through the Bluetooth connection in order to switch on or off the car lights: if the configuration descriptor of the present characteristic is the opening descriptor, the configuration descriptor of the characteristic is amended as the closing descriptor on the car through the Bluetooth connection to switch off the car lights; if the configuration descriptor of the present characteristic is the closing descriptor, the configuration descriptor of the characteristic is amended as the opening descriptor on the car through the Bluetooth connection to switch on the car lights.

9. The electronic device according to claim 6, further, wherein execution of the instructions by the at least one processor causes the at least one processor to:
calculate the link loss of Bluetooth connection; when the link loss is more than or equal to the preset link loss threshold, the configuration descriptors of the characteristics are amended through the Bluetooth connection in order to switch off the car lights.

10. The electronic device according to claim 9, wherein calculate the link loss of Bluetooth connection comprising:
monitor the received signal intensity of Bluetooth connection and reading the transmitting power of the car lights;
calculate a difference value between the intensity of received signals and the transmitting power of the car lights, and taking the difference value as the link loss.

11. A non-transitory computer readable media having computer programs stored thereon that, when executed by one or more processors of an electronic device, cause the electronic device to perform:
receive the UUID broadcast by the car lights;
configure light control services corresponding to the car lights, characteristics of the light control services, and configuration descriptors of the characteristics and establish Bluetooth connection with the car lights according to the UUID;
amend the configuration descriptors of the characteristics on the car through the Bluetooth connection in order to switch on or off the car lights.
